(19) United States
(12) Patent Application Publication
(10) Pub. No.: US 2016/0019433 A1
(43) Pub. Date: Jan. 21, 2016

(54) IMAGE PROCESSING SYSTEM, CLIENT, IMAGE PROCESSING METHOD, AND RECORDING MEDIUM

(71) Applicant: FUJIFILM Corporation, Tokyo (JP)

(72) Inventor: Masaki SAITO, Tokyo (JP)

(21) Appl. No.: 14/800,713

(22) Filed: Jul. 16, 2015

(30) Foreign Application Priority Data
Jul. 16, 2014 (JP) 2014-145657

(51) Int. Cl. G06K 9/46; G06T 1/20; G06K 9/62; G06F 17/30; H04L 29/06; G06K 9/52

(52) U.S. Cl. CPC G06K 9/4671; H04L 67/42; G06K 9/52; G06K 9/6201; G06F 17/30268; G06T 1/20

(57) ABSTRACT

An image processing system shares image processing on an image through sharing between a server and a client. The image processing system calculates a degree of interest of the user in the image based on operation information indicating information regarding an operation performed by a user, and information regarding the image, determines whether the degree of interest is equal to or greater than a first threshold value, and performs control so that the image processing is performed in the client on the image in which the degree of interest is determined to be equal to or greater than the first threshold value, and the image processing is performed in the server on the image in which the degree of interest is determined to be smaller than the first threshold value.

### CROSS-REFERENCE TO RELATED APPLICATIONS

The present application claims priority under 35 U.S.C. §119 to Japanese Patent Application No. 2014-145657, filed on Jul. 16, 2014. Each of the above application(s) is hereby expressly incorporated by reference, in its entirety, into the present application.

### BACKGROUND OF THE INVENTION

1. Field of the Invention

The present invention relates to an image processing system that shares image processing on a plurality of images between a server and a client, the client, an image processing method, and a recording medium.

2. Description of the Related Art

With the spread of mobile terminals such as a smart phone or a tablet PC (personal computer), an opportunity of capturing an image such as a still image or a moving image and storing the image in the mobile terminal increases. In the mobile terminal, various image processing such as image correction, image analysis, or moving image processing can be performed on a still image or a moving image using a mobile application for performing image editing or ordering.

Image processing schemes include two patterns below according to a place in which image processing is actually performed, as illustrated in FIG. 12.

(1) Client processing: Image processing is performed on a mobile terminal, and an image after image processing subjected to client processing is obtained as an image processing result.
(2) Server processing: An image held in the mobile terminal is transmitted to a serer over a network and image processing is performed on the server. Then, the image after image processing is transmitted from the server to the mobile terminal, and the image after image processing subjected to server processing is obtained as an image processing result.

In the case of client processing, there is an advantage in that a load of the mobile terminal is high, but responsiveness of the image processing is high.

However, performance of the mobile terminal is inferior to a general PC or server. Therefore, there is a problem in that, when a large number of image processing is performed, the load of the mobile terminal increases, a processing speed decreases, and operability of the user is impaired.

On the other hand, in the case of server processing, there is an advantage in that the responsiveness of the image processing is low, but the load of the mobile terminal is low. However, it is necessary for the image to be transmitted from the mobile terminal to the server and for a processing result to be transmitted from the server to the terminal Therefore, there is a problem in that a waiting time is generated and the operability of the user is impaired while communication is being performed between the mobile terminal and the server.

There are JP2010-108036A, JP2010-245862A, JP2014-16819A, JP2010-79683A, and JP2010-206534A as related art considered to be relevant to the present invention.

In JP2010-108036A, a medical image processing system in which an image processing process shared between a client computer and a server computer is dynamically distributed based on an amount of traffic and a transmission capability of a network between the server computer and the client computer, a load situation and a processing capability of the server computer, and a load situation and a processing capability of the client computer is described.

In JP2010-245862A, a medical image processing apparatus in which a processing load is predicted based on an examination schedule, an image processing load, a load that can be subjected to image processing in a server, a processing capability of a client terminal, or the like, and it is determined whether the image processing is performed on a medical image in a server or in the client terminal based on the prediction result is described.

In JP2014-16819A, it is described that a degree of interest indicating how much a user is interested in the image is calculated using elements such as the number of the accesses caused by a viewing request instruction for the image, and an image evaluation value.

In JP2010-79683A, it is described that a phrase input a predetermined number of times or more by a user or a phrase described in operation history information of an application included in a portable telephone or viewing history information for a website is extracted, and the preference of the user is analyzed based on the extracted phrase.

JP2010-206534A, it is described that use history information relating to a use history of a portable terminal device of a user is received from the portable terminal device of the user, and a target of interest of the user is analyzed based on the received use history information.

### SUMMARY OF THE INVENTION

An object of the present invention is to provide an image processing system, a client, an image processing method, and a recording medium capable of solving the problems of the related art and performing desired image processing on an image that is an image processing target without impairing operability of a user.

In order to achieve the object, according to an aspect of the present invention, there is provided an image processing system which shares image processing on a plurality of images between a server and a client connected to the server over a network. The server includes a first image processing unit configured to perform image processing on an image received from the client. The client includes: a degree-of-interest calculation unit configured to calculate a degree of interest of the user in the image based on operation information, which is indicative of information regarding an operation performed by a user, and information regarding the image; a degree-of-interest determination unit configured to determine whether the degree of interest is equal to or greater than a first threshold value; a second image processing unit configured to perform image processing on the image; and a control unit configured to control the second image processing unit to perform the image processing of the image for which the degree of interest is determined to be equal to or greater than the first threshold value in a case where the degree-of-interest determination unit determines that the degree of interest is equal to or greater than the first threshold value, and to control the first image processing unit to perform the image processing on the image for which the degree of interest is determined to be smaller than the first threshold value in a case where the degree-of-interest determination unit determines that the degree of interest is smaller than the first threshold value.

In the image processing system according to the aspect of the present invention, the server may further include a first transfer unit configured to transfer data regarding the image processing between the server and the client. The client may further include a second transfer unit configured to transfer the data between the client and the server. In the case where the image processing is performed by the first image processing unit, the control unit may control: the second transfer unit to transmit data regarding image processing of the image for which the degree of interest is determined to be smaller than the first threshold value from the client to the server; the first transfer unit to receive the data regarding image processing of the image for which the degree of interest is determined to be smaller than the first threshold value from the client to the server; the first image processing unit to perform image processing on the image in which the degree of interest is determined to be smaller than the first threshold value based on the data regarding image processing of the image in which the degree of interest is determined to be smaller than the first threshold value; the first transfer unit to transmit the image on which the image processing has been performed from the server to the client; and the second transfer unit to receive the image on which the image processing has been performed from the server to the client.

In the image processing system according to the aspect of the present invention, the operation information of the user may include at least one information type selected from a group of types consisted of image viewing, image editing, image ordering, and image sharing.

In the image processing system according to the aspect of the present invention, the information regarding the image may include at least one information type selected from a group of types consisted of an owner of the image, a subject of the image, a photographing date and time of the image, a size of the image, and meta information of the image.

In the image processing system according to the aspect of the present invention, the degree-of-interest calculation unit may calculate the degree of interest based on, as a calculation criterion of the degree of interest, one of calculation criterions or in combination of two or more of the calculation criteria: (1) Whether the image that is an image processing target is an image currently operated by the user; (2) Whether a photographing date of the image that is an image processing target is the same as a photographing date of an image currently operated by the user; (3) Whether the user operated the image that is an image processing target in the past; (4) Whether the number of times the user operated the image that is an image processing target in the past is greater than a second threshold value; (5) Whether a time for which the user operated the image that is an image processing target in the past is longer than a third threshold value; (6) Whether the image that is an image processing target is an image that the user has uploaded to an SNS; (7) Whether the image that is an image processing target is an image that the user has transmitted to another user; (8) Whether the image that is an image processing target is an image for which the user performed a print order in the past; (9) Whether the image that is an image processing target is an image of which an original owner is the user or a user's family; (10) Whether a subject included in the image that is an image processing target is the user or a user's family, or a subject matching user's preference; (11) Whether a face of a subject included in the image that is an image processing target is larger than a fourth threshold value; (12) Whether the number of subjects included in the image that is an image processing target is greater than a fifth threshold value; (13) Whether a photographing date and time of the image that is an image processing target is an anniversary of the user or a user's family; (14) Whether a photographing date and time of the image that is an image processing target is more recent than a sixth threshold value; (15) Whether the number of pixels of the image that is an image processing target is greater than a seventh threshold value; (16) Whether an aspect ratio of the image that is an image processing target is different from an aspect ratio of anther image; (17) Whether the image that is an image processing target is an image captured in a different photographing method from another image; (18) Whether the image that is an image processing target is an image captured the number of times equal to or greater than a ninth threshold value in a period of time shorter than an eighth threshold value; (19) Whether a photographing interval between the image that is an image processing target and an image captured before the image that is an image processing target is greater than a tenth threshold value; (20) Whether a photographing place of the image that is an image processing target is farther than an eleventh threshold value from within a living area of the user; (21) Whether the image that is an image processing target is a moving image, and a photographing time period of the image is greater than a twelfth threshold value; (22) Whether the image that is an image processing target is an image which has been processed by the user or an image which has been subjected to a plurality of types of processing; and (23) Whether the image that is an image processing target is an image of which a photographing frequency is statistically higher than a thirteenth threshold value, or an image of which the photographing frequency is statistically lower than a fourteenth threshold value.

In the image processing system according to the aspect of the present invention, the degree-of-interest calculation unit may perform weighting on the calculated degree of interest based on each of the calculation criteria according to a degree of importance of each calculation criterion.

In the image processing system according to the aspect of the present invention, in a case where the degree-of-interest calculation unit calculates the degree of interest in a combination of two or more of the calculation criteria, the degree-of-interest calculation unit may select two or more calculation criteria of which the weight is equal to or greater than a fifteenth threshold value from among the two or more calculation criteria, and calculate the degree of interest on which the weighting has been performed in combination of the two or more selected calculation criteria.

In the image processing system according to the aspect of the present invention, the client may further include a degree-of-interest recording unit configured to store a history of the calculation criteria for the degree of interest and a calculation result each time the degree-of-interest calculation unit calculates the degree of interest, and the degree-of-interest calculation unit may calculate the degree of interest based on the history of the calculation criteria for the degree of interest and the calculation result, in addition to the operation information of the user and the information regarding the image.

In the image processing system according to the aspect of the present invention, the degree-of-interest calculation unit may use a result of calculation of the degree of interest corresponding to the operation information of the user and the information regarding the image from the history of the result of calculation of the degree of interest, as the calculated degree of interest.

In the image processing system according to the aspect of the present invention, the degree-of-interest calculation unit may calculate the degree of interest based on a sensitivity tag indicative of sensitivity of the image, which tag is given to the image as the information regarding the image.

In the image processing system according to the aspect of the present invention, the degree-of-interest calculation unit may calculate an occupancy rate of each sensitivity tag in an image that is a current image processing target based on the information regarding the sensitivity tag given to each image that is the current image processing target as the degree of interest.

In the image processing system according to the aspect of the present invention, the degree-of-interest calculation unit may calculate the number of images to which respective sensitivity tags have been given among images that are current image processing targets based on information regarding the sensitivity tags given to the respective images that are the current image processing targets as the degree of interest.

In the image processing system according to the aspect of the present invention, the degree-of-interest calculation unit may calculate the degree of interest based on statistical information of images that are past image processing targets and sensitivity tags.

In the image processing system according to the aspect of the present invention, the degree-of-interest calculation unit may perform weighting on the degree of interest calculated based on the statistical information according to the operation information of the user.

In the image processing system according to the aspect of the present invention, the control unit may control the server to holds, after the image processing is performed by the first image processing unit, the image on which the image processing has been performed until the client requires the image on which the image processing has been performed, and controls the client to receives the image on which the image processing has been performed from the server when the client requires the image on which the image processing has been performed.

In the image processing system according to the aspect of the present invention, the control unit may control the second image processing unit to perform image processing on the image of which the size is equal to or greater than a sixteenth threshold value regardless of the degree of interest in a case where the size of the image is equal to or greater than the sixteenth threshold value, and controls the first image processing unit to perform the image processing on the image of which the size is less than a seventeenth threshold value regardless of the degree of interest in a case where the size of the image is less than the seventeenth threshold value, which is smaller than the sixteenth threshold value.

In the image processing system according to the aspect of the present invention, in a case where the image in which the degree of interest has been calculated is subjected to the image processing by the second image processing unit or the image in which the degree of interest has been calculated is operated by the user before the image is transmitted to the server, the degree-of-interest calculation unit may re-calculate the degree of interest of the user in the image in which the degree of interest has been calculated, based on the operation information of the user for the image in which the degree of interest has been calculated, which has been operated by the user.

In the image processing system according to the aspect of the present invention, in a case where an image in which the degree of interest has been calculated is operated by the user, the degree-of-interest calculation unit may store operation information of the user for the image in which the degree of interest has been calculated for a certain period of time, and re-calculate the degree of interest of the user in the image in which the degree of interest has been calculated, based on the operation information of the user for the image in which the degree of interest has been calculated, which is stored for the certain time.

In the image processing system according to the aspect of the present invention, in a case where the degree-of-interest calculation unit calculates the degree of interest based on the number of times or a period of time for which the user operated the image in the past, the degree-of-interest calculation unit may do not count the number of re-operations or a re-operation period of time in the number of times or the period of time for which the user operated the image in the past if the operation and the re-operation are performed the number of times less than an eighteenth threshold value by the user.

In the image processing system according to the aspect of the present invention, in a case where the operation and the re-operation are performed the number of times equal to or greater than the eighteenth threshold value by the user, the degree-of-interest calculation unit may count the number or the time of re-operations in the number of times or time for which the user operated the image in the past.

In the image processing system according to the aspect of the present invention, in a case where the degree-of-interest calculation unit calculates the degree of interest based on a period of time for which the user operated an image in the past, if the image has not been operated for a certain period of time by the user, the certain period of time for which the image has not been operated by the user may be not counted in a period of time for which the user operated the image in the past.

In the image processing system according to the aspect of the present invention, in a case where the image processing is performed by the second image processing unit, the control unit may control the second image processing unit to increase the number of images simultaneously subjected to the image processing in accordance with increase of performance of the client.

In the image processing system according to the aspect of the present invention, in a case where the image processing is performed by the second image processing unit, the control unit may control the second image processing unit to decrease the number of images subjected to the image processing in accordance with increase of a load of the client.

In the image processing system according to the aspect of the present invention, in a case where the image processing is unable to be performed by the first image processing unit due to an operation situation of the server, the control unit may control the second image processing unit to perform the image processing.

In the image processing system according to the aspect of the present invention, in a case where a communication speed between the client and the server is equal to or greater than a nineteenth threshold value, the control unit may control the image processing unit to increase the number of images subjected to image processing.

In the image processing system according to the aspect of the present invention, n a case where a communication line of a use-based billing scheme is used between the client and the server, the control unit may control the first image processing unit to decrease the number of images subjected to image processing.

In the image processing system according to the aspect of the present invention, in a case where there are two or more servers, the control unit may perform control in such a manner that the image processing is performed on an image in which the degree of interest is higher in a server in which time required for image processing is shorter.

In the image processing system according to the aspect of the present invention, in a case where there are two or more servers, the control unit may perform control in such a manner that a desired image processing is performed in a server that provides a function of performing the desired image processing.

In the image processing system according to the aspect of the present invention, in a case where there are two or more clients, the control unit may control a client that is currently operated by the user to perform image processing on an image having a higher degree of interest than an image on which image processing is performed by a client that is not currently operated by the user.

In the image processing system according to the aspect of the present invention, the client may further include an image processing place designation unit configured to designate a place at which the image processing is performed, and the control unit may control the first image processing unit or the second image processing unit to perform the image processing according to the place at which the image processing is performed, which is designated by the image processing place designation unit.

In the image processing system according to the aspect of the present invention, the image processing place designation unit may display a GUI screen for enabling the user to designate a place at which the image processing is performed on a display unit of a client currently operated by the user.

In the image processing system according to the aspect of the present invention, the control unit may determine whether remaining processes of the image processing continue to be performed by the second image processing unit or are performed by the first image processing unit based on the degree of interest after only some of processes of the image processing are performed by the second image processing unit.

In the image processing system according to the aspect of the present invention, the control unit may perform control in such a manner that the image processing is performed in the client in a case where the image processing is image processing in which the user is able to visually confirm a processing result, and the image processing is performed in the server when the image processing is image processing in which the user is unable to visually confirm a processing result.

According to another aspect of the invention, there is provided a client used in an image processing system which shares image processing on a plurality of images between a server and a client connected to the server over a network. The client includes: a degree-of-interest calculation unit configured to calculate a degree of interest of the user in the image based on operation information, which is indicative of information regarding an operation performed by a user, and information regarding the image; a degree-of-interest determination unit configured to determine whether the degree of interest is equal to or greater than a first threshold value; a second image processing unit configured to perform image processing on the image; and a control unit configured to control the second image processing unit to perform the image processing on the image in which the degree of interest is determined to be equal to or greater than the first threshold value in a case where the degree-of-interest determination unit determines that the degree of interest is equal to or greater than the first threshold value, and controls a first image processing unit included in the server to perform the image processing on the image in which the degree of interest is determined to be smaller than the first threshold value in a case where the degree-of-interest determination unit determines that the degree of interest is smaller than the first threshold value.

In the client according to the aspect of the present invention, the client may further include a second transfer unit configured to transfer data regarding the image processing between the client and the server. In the case where the image processing is performed by the first image processing unit, the control unit may control: the second transfer unit to transmit data regarding image processing of the image in which the degree of interest is determined to be smaller than the first threshold value from the client to the server by the second transfer unit; the first transfer unit included in the server to receive the data regarding image processing of the image in which the degree of interest is determined to be smaller than the first threshold value from the client to the server; the first image processing unit to perform image processing on the image in which the degree of interest is determined to be smaller than the first threshold value based on the data regarding image processing of the image in which the degree of interest is determined to be smaller than the first threshold value; the first transfer unit to transmit the image on which the image processing has been performed from the server to the client; and the second transfer unit to receive the image on which the image processing has been performed from the server to the client.

According to still another aspect of the invention, there is provided an image processing method for performing image processing on a plurality of images through sharing between a server and a client connected to the server over a network. The method includes: causing a degree-of-interest calculation unit of the client to calculate a degree of interest of the user in the image based on operation information, which is indicative of information regarding an operation performed by a user, and information regarding the image; causing a degree-of-interest determination unit of the client to determine whether the degree of interest is equal to or greater than a first threshold value; and causing a control unit to control the second image processing unit of the client to perform image processing on the image in which the degree of interest is determined to be equal to or greater than the first threshold value in a case where the degree-of-interest determination unit determines that the degree of interest is equal to or greater than the first threshold value, and control the first image processing unit of the server to perform the image processing on the image in which the degree of interest is determined to be smaller than the first threshold value in a case where the degree-of-interest determination unit determines that the degree of interest is smaller than the first threshold value.

In the image processing method according to the aspect of the present invention, the method further including: in a case where the image processing is performed by the first image processing unit, causing a second transfer unit of the client to transmit data regarding image processing of the image in which the degree of interest is determined to be smaller than the first threshold value from the client to the server; causing a first transfer unit of the server to receive the data regarding image processing of the image in which the degree of interest is determined to be smaller than the first threshold value from the client to the server; causing the first image processing unit to perform image processing on the image in which the degree of interest is determined to be smaller than the first threshold value based on the data regarding image processing of the image in which the degree of interest is determined to be smaller than the first threshold value; causing the first transfer unit to transmit an image on which the image processing has been performed from the server to the client; and causing the second transfer unit to receive the image on which the image processing has been performed from the server to the client.

According to still another aspect of the invention, there is provided a computer-readable non-transitory recording medium having a program recorded thereon for causing a computer to execute each of the image processing methods according to the aspect of the present invention.

In the present invention, since a plurality of images that are image processing targets are subjected to image processing through sharing between the server and the client, it is possible to reduce a load of the client. Further, since the user does not immediately require an image processing result of the image having a low degree of interest, it is considered that waiting time for communication between the server and the client is not concerned. Therefore, according to the present invention, it is possible to perform image processing without impairing operability of the user.

### BRIEF DESCRIPTION OF THE DRAWINGS

FIG. 1 is a block diagram of an embodiment illustrating a configuration of an image processing system of the present invention.

FIG. 2 is a block diagram of an embodiment illustrating a configuration of a server illustrated in FIG. 1.

FIG. 3 is a block diagram of an embodiment illustrating an internal configuration of a client illustrated in FIG. 1.

FIG. 4 is a flowchart of an embodiment illustrating an operation of the image processing system.

FIG. 5 is a flowchart of another embodiment illustrating an operation of the image processing system.

FIG. 6 is a conceptual diagram of an example illustrating images owned by a user.

FIG. 7 is a conceptual diagram of an example illustrating some images displayed on a display unit among the images illustrated in FIG. 6.

FIG. 8 is a conceptual diagram of an example illustrating images in another portion displayed on the display unit among the images illustrated in FIG. 6.

FIG. 9 is a flowchart of another embodiment illustrating the operation of the image processing system.

FIG. 10 is a conceptual diagram of an example illustrating a GUI screen for enabling a user to designate a place in which image processing is performed.

FIG. 11 is a flowchart of another embodiment illustrating the operation of the image processing system.

FIG. 12 is a conceptual diagram of an example illustrating client processing and server processing as image processing schemes.

### DESCRIPTION OF THE PREFERRED EMBODIMENTS

Hereinafter, an image processing system, a client, an image processing method, and a recording medium of the present invention will be described in detail based on preferred embodiments shown in the accompanying drawings.

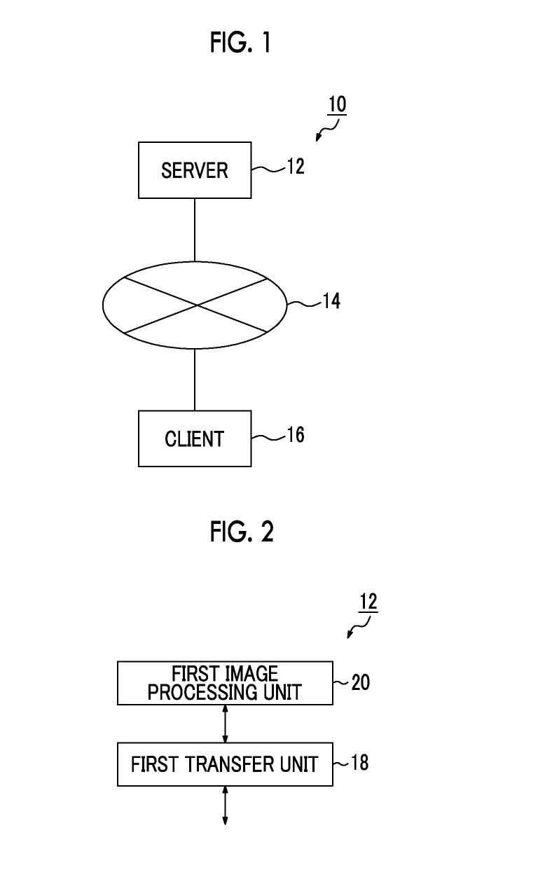

FIG. 1 is a block diagram of an embodiment illustrating a configuration of an image processing system of the present invention. The image processing system 10 illustrated in FIG. 1 includes a server 12, and a client 16 connected to the server 12 over a network 14. The image processing system 10 performs desired image processing on a plurality of images (including both a still image and a moving image) held in the client 16 used by the user through sharing between the server 12 and the client 16.

FIG. 2 is a block diagram of an embodiment illustrating a configuration of the server illustrated in FIG. 1. The server 12 includes, for example, a control device including a CPU (central processing unit) or the like, a storage device including a hard disk, a memory or the like, a communication device including a communication module, or the like. The server 12 illustrated in FIG. 2 includes a first transfer unit 18, and a first image processing unit 20. The first transfer unit 18 includes, for example, a communication device. The first image processing unit 20 is realized, for example, by the control device executing a program loaded into a memory.

The first transfer unit 18 transfers various pieces of data regarding image processing, such as an image (image data) that is an image processing target, content of image processing, and an image (image data) on which the image processing has been performed, between the server 12 and the client 16.

The first image processing unit 20 performs image processing (server process) on an image that is an image processing target received from the client 16 based on data that the first transfer unit 18 has received from the client 16.

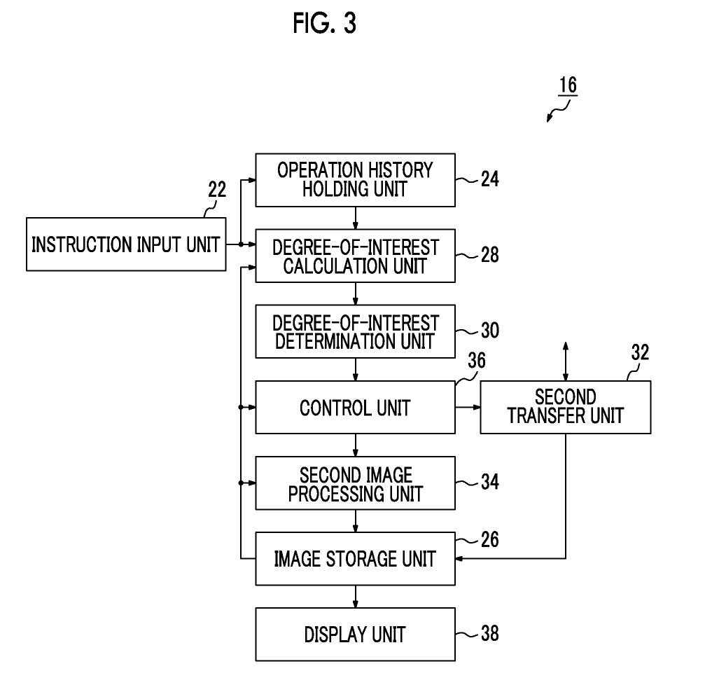

FIG. 3 is a block diagram of an embodiment illustrating an internal configuration of the client illustrated in FIG. 1. The client 16 is a mobile terminal such as a smart phone, a tablet terminal, a PC, or the like, and includes an instruction input unit 22, an operation history holding unit 24, an image storage unit 26, a degree-of-interest calculation unit 28, a degree-of-interest determination unit 30, a second transfer unit 32, a second image processing unit 34, a control unit 36, and a display unit 38, as illustrated in FIG. 3. The instruction input unit 22 includes, for example, an input device such as a mouse, a keyboard, or a touch sensor. The operation history holding unit 24 and the image storage unit 26 include a storage device. The degree-of-interest calculation unit 28, the degree-of-interest determination unit 30, and the second image processing unit 34 are realized, for example, by the control device executing a program loaded into a memory. The display unit includes, for example, a display device such as a liquid crystal display.

The instruction input unit 22 receives various instructions (current operation situation of the user) inputted by an operation of a user.

The operation history holding unit 24 holds a history (past operation history of the user) of the instruction received by the instruction input unit 22.

Here, the current operation situation of the user indicates an operation currently performed by the user. The past operation history of the user indicates an operation performed by the user in the past. In the present embodiment, the current operation situation of the user and the past operation history are collectively referred to operation information of the user. That is, the operation information of the user indicates information of the operation performed by the user, and includes one or more pieces of information among image viewing, image editing, image order (for example, printing or photo-book order), and image sharing.

The image storage unit 26 holds, for example, an image (image data) that is an image processing target, information regarding the image, and an image (image data) on which the image processing has been performed.

Here, the information regarding the image include, for example, one or more pieces of information among an owner of the image, a subject of the image, a photographing date and time of the image, a size of the image, and meta information (for example, Exif (Exchangeable image file format) information) of the image.

The current operation situation of the user from the instruction input unit 22, the past operation history of the user from the operation history holding unit 24, and the information regarding the image from the image storage unit 26 are input to the degree-of-interest calculation unit 28.

The degree-of-interest calculation unit 28 calculates a degree of interest of the user in the image, for example, as 10 steps based on the operation information of the user (the current operation situation and the past operation history of the user), and the information regarding the image. Here, as a numerical value of the degree of interest is greater, the degree of interest is higher.

The degree-of-interest determination unit 30 determines whether the degree of interest calculated by the degree-of-interest calculation unit 28 is equal to or greater than a first threshold value which is set in advance.

The second transfer unit 32 transfers various pieces of data regarding the image processing described above between the client 16 and the server 12.

The second image processing unit 34 performs image processing (client processing) on the image that is an image processing target based on the above-described data.

The control unit 36 performs control so that image processing is performed on the image in which the degree of interest is determined to be equal to greater than the first threshold value by the second image processing unit 34 when the degree-of-interest determination unit 30 determines that the degree of interest is equal to or greater than the first threshold value, and so that image processing is performed on the image in which the degree of interest is determined to be smaller than the first threshold value by the first image processing unit 20 when the degree-of-interest determination unit 30 determines that the degree of interest is smaller than the first threshold value.

Hereinafter, the image processing performed on the image by the second image processing unit 34 may be referred to as “client processing”. Further, the image processing performed on the image by the first image processing unit 20 may be referred to as “server processing”.

The display unit 38 displays, for example, an image that is an image processing target, an image on which the image processing has been performed, and a screen for enabling the user to input an instruction regarding the image that is an image processing target or content of the image processing.

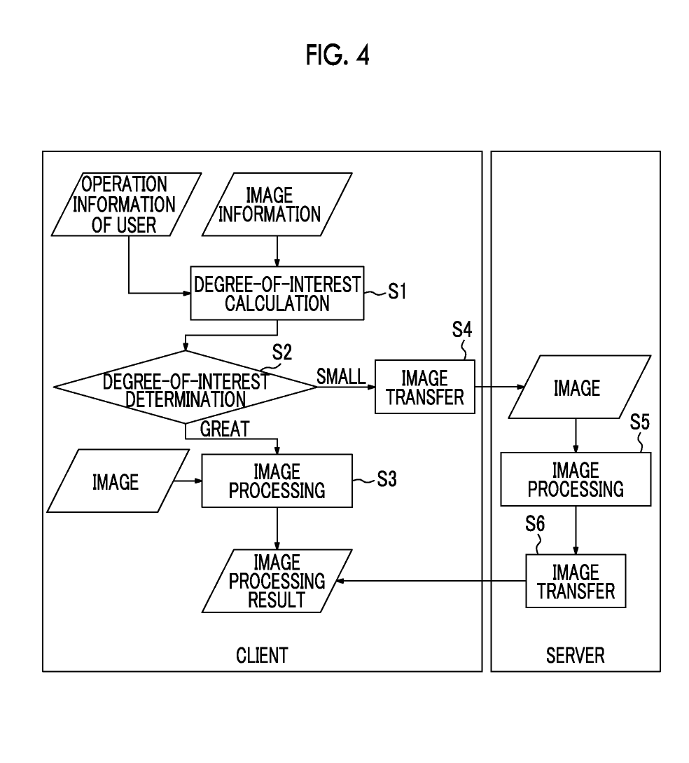

Next, an operation of the image processing system 10 will be described according to the image processing method of the present invention with reference to a flowchart illustrated in FIG. 4.

When the instruction input unit 22 receives an instruction to perform image processing on the image that is an image processing target, the degree-of-interest calculation unit 28 calculates the degree of interest of the user in the image based on the operation information of the user and the information regarding the image (image information) (step S1).

Then, the degree-of-interest determination unit 30 determines whether the degree of interest is equal to or greater than the first threshold value (greater or smaller than the first threshold value) (step S2).

Here, when the degree-of-interest determination unit 30 determines that the degree of interest is equal to or greater than the first threshold value (“great” in step S2), the control unit 36 performs control so that image processing is performed in the client 16.

In this case, the second image processing unit 34 performs image processing on the image in which the degree of interest is determined to be equal to or greater than the first threshold value (step S3), and the image on which the image processing has been performed by the client is stored as a result of the image processing in the image storage unit 26.

On the other hand, if the degree-of-interest determination unit 30 determines that the degree of interest is smaller than the first threshold value (“small” in step S2), the control unit 36 performs control so that image processing is performed in the server 12.

In this case, the second transfer unit 32 transmits data regarding the image processing of the image in which the degree of interest is determined to be smaller than the first threshold value from the client 16 to the server 12, and the first transfer unit 18 receives the data (step S4).

Subsequently, the first image processing unit 20 performs image processing on the image in which the degree of interest is determined to be smaller than the first threshold value based on the data that the first transfer unit 18 has received from the client 16 (step S5).

Subsequently, the first transfer unit 18 transfers the image on which the image processing has been performed of the image in which the degree of interest is determined to be smaller than the first threshold value from the server 12 to the client 16, and the second transfer unit 32 receives the image (step S6). The image on which the image processing has been performed by the server is stored as a result of the image processing in the image storage unit 26.

In the image processing system 10, a plurality of images that are image processing targets are subjected to image processing through sharing between the server 12 and the client 16, and thus, it is possible to reduce a load of the client 16. Further, since the user does not immediately require the image processing result of the image having a low degree of interest, waiting time for communication between the server 12 and the client 16 is considered not to be concerned. Therefore, the image processing system 10 can perform image processing without impairing operability of the user.

Next, a specific example of calculation criteria for the degree of interest will be described.

Here, calculation criteria 1 to 23 below are illustrated as calculation criteria when the degree-of-interest calculation unit 28 calculates the degree of interest.

1. Whether the image that is an image processing target is an image currently operated (for example, viewed or edited) by the user.

The image currently operated by the user can be considered as having a higher degree of interest of the user than an image that is not being operated. On the other hand, an image less relevant to the image currently operated by the user (an image having an image photographing date and time, a file name, or the like different from the image that is being operated) can be considered as having a lower degree of interest of the user than an image more relevant to the image currently operated by the user.

2. Whether a photographing date of the image that is an image processing target is the same as a photographing date of an image currently operated by the user.

An image captured on the same date as the image currently operated by the user can be considered as having a higher degree of interest of the user than an image of which the photographing date is different from the photographing date of the currently operated image.

3. Whether the User Operated the Image that is an Image Processing Target in the Past.

An image operated by the user in the past can be considered as having a higher degree of interest of the user than an image not operated by the user in the past at all.

4. Whether the number of times the user operated the image that is an image processing target in the past is greater than a second threshold value set in advance.

An image of which the number of times the user operated the image in the past is great can be considered as having a higher degree of interest of the user than an image of which the number of times the user operated the image in the past is small. For example, when the second threshold value is 3, the interest of the user is determined to be high if a cumulative number of operations is equal to or greater than 5, and the interest of the user is determined to be low if the cumulative number of operations is equal to or less than 2.

5. Whether a period of time for which the user operated the image that is an image processing target in the past is longer than a third threshold value set in advance.

An image of which a time for which the user operated the image in the past is long can be considered as having a higher degree of interest of the user than an image of which a time for which the user operated the image in the past is short. For example, when the third threshold value is 45 seconds, the interest of the user is determined to be high if a cumulative operation time is equal to or more than one minute and low if the cumulative operation time is equal to or less than 30 seconds.

6. Whether the image that is an image processing target is an image that the user has uploaded to an SNS (social networking service).

An image shared by the user uploading to the SNS can be considered as having a higher degree of interest of the user than an image not uploaded and shared.

7. Whether the image that is an image processing target is an image that the user has transmitted to another user.

An image transmitted from the user to another user using an e-mail or a messaging application and shared can be considered as having a higher degree of interest of the user than an image not transmitted and shared.

8. Whether the image that is an image processing target is an image for which the user performed a print order in the past.

An image for which the user performed a print order in the past can be considered as having a higher degree of interest of the user than an image for which the user had not performed a print order. Conversely, since such an image is an image that has already been ordered, the degree of interest of the user can also be considered to be low.

9. Whether the image that is an image processing target is an image of which an original owner is the user or a user's family.

An image captured by the user or a user's family can be considered as having a higher degree of interest of the user than images captured by other users.

10. Whether a subject included in the image that is an image processing target is the user or a user's family, or a subject matching user's preference (a landscape, a car, a night view, or the like).

An image in which the user or the user's family has been photographed or an image in which a subject matching the user's preference has been photographed can be considered as having a higher degree of interest of the user than other images.

11. Whether a face of a subject included in the image that is an image processing target is larger than a fourth threshold value set in advance.

An image in which a face of the subject is photographed to be large can be considered as having a higher degree of interest of the user than an image in which the face of the subject is photographed to be small.

12. Whether the number of subjects included in the image that is an image processing target is greater than a fifth threshold value set in advance.

An image in which the number of subjects is large like a group photograph can be considered as having a higher degree of interest of the user than an image in which the number of subjects is small.

13. Whether the image that is an image processing target is an image of which the photographing date and time is an anniversary of the user or a user's family.

An image captured on an anniversary can be considered as having a higher degree of interest of the user than an image captured on other days.

14. Whether photographing date and time of the image that is an image processing target is more recent than a sixth threshold value set in advance.

A recently captured image (an image of which the photographing date and time is new) can be considered as having a higher degree of interest of the user than an image of which the photographing date and time is older.

15. Whether the image that is an image processing target is an image having the number of pixels greater than a seventh threshold value set in advance.

An image captured with high resolution (an image having a large number of pixels) can be considered as having a higher degree of interest of the user than an image captured with low resolution (an image having a small number of pixels)

16. Whether the image that is an image processing target is an image having a different aspect ratio from another image.

An image (panorama image, a square image, or the like) captured at a special aspect ratio can be considered as having a higher degree of interest of the user than an image captured at a normal aspect ratio (an image having an aspect ratio of 4:3 or 3:2).

17. Whether the image that is an image processing target is an image captured in a different photographing method from another image.

An image captured using a different special photographing method (HDR (High Dynamic Range imaging) photographing, bracket photographing, or the like) from another image can be considered as having a higher degree of interest of the user than an image captured using a normal photographing method.

18. Whether the image that is an image processing target is an image captured the number of times equal to or greater than a ninth threshold value set in advance in a period of time shorter than an eighth threshold value set in advance.

An image captured several times in a short time is an important image desired not to be failed, and can be considered as having a higher degree of interest of the user than an image captured at a time interval.

19. Whether a time interval between the image that is an image processing target and an image captured before the image that is an image processing target is greater than a tenth threshold value set in advance.

An image captured after a long photographing interval is an image captured at a timing of switching of an event, and can be considered as having a higher degree of interest of the user than an image captured at a normal photographing interval.

20. Whether a photographing place of the image that is an image processing target is farther than an eleventh threshold value set in advance from within a living area of the user.

An image of which the photographing place is far away from within the living area of the user is an image captured at an overseas travel destination or the like, and can be considered as having a higher degree of interest of the user than an image of which the photographing place is within a daily living area.

21. Whether the image that is an image processing target is a moving image, and a photographing time of the moving image is greater than a twelfth threshold value set in advance.

A moving image of which the photographing time is long can be considered as having a higher degree of interest of the user than a moving image of which the photographing time is short.

22. Whether the image that is an image processing target is an image processed by the user (image processing) or an image subjected to a plurality of types of processing.

An image processed over time by the user can be considered as having a higher degree of interest of the user than a non-processed image.

23. Whether the image that is an image processing target is an image of which a photographing frequency is statistically higher than a thirteenth threshold value set in advance, or an image of which the photographing frequency is statistically lower than a fourteenth threshold value set in advance.

An image satisfying a frequent photographing condition (for example, there are images captured in the evening, and there are images captured with a wide angle) can be considered as having a higher degree of interest of the user than the other images. Conversely, an image satisfying a usually infrequent condition can be considered as having a higher degree of interest of the user than an image satisfying a frequent photographing condition.

The degree-of-interest calculation unit 28 calculates the degree of interest corresponding to each calculation criterion, for example, as 10 steps based on each calculation criterion. Further, the degree-of-interest calculation unit 28 can calculate the degree of interest based on one of the calculation criteria or a combination of two or more of the calculation criteria.

Further, the calculation criteria are not limited to calculation criteria 1 to 23 described above, and various other calculation criteria can be similarly used.

Further, since degrees of importance of the respective calculation criteria for the degree of interest are different, it is preferable for the degree-of-interest calculation unit 28 to perform weighting of the degree of interest calculated based on each calculation criterion according to the degree of importance of each calculation criterion.

For example, here, calculation criteria 1 to 23 described above are classified into five groups: calculation criteria 1 and 2 indicating a current operation situation of the user, calculation criteria 3 to 8 indicating a past operation history of the user, calculation criteria 9 to 13 indicating personal information, calculation criteria 14 to 20 indicating photographic information, and other calculation criteria 21 to 23. In this case, for example, since calculation criteria 1 and 2 indicating a current operation situation of the user are more important than the other calculation criteria, a relatively greater weight is considered to be set for calculation criteria 1 and 2 indicating a current operation situation of the user than for the other groups of calculation criteria.

For example, when weighting is performed in five steps, a weight of 5, which is a greatest value, is applied to calculation criteria 1 and 2 indicating a current operation situation of the user. Weights are applied to the other groups of calculation criteria other than calculation criteria 1 and 2 indicating a current operation situation of the user according to their degrees of importance. For example, a weight of 3 is applied to calculation criteria 3 to 8 of the past operation history of the user, a weight of 4 is applied to calculation criteria 9 to 13 of personal information, a weight of 1 is applied to calculation criteria 14 to 20 of photographic information, and a weight of 3 is applied to other calculation criteria 21 to 23.

When the degree-of-interest calculation unit 28 calculates the weighted degree of interest based on one calculation criterion, the degree-of-interest calculation unit 28 calculates the degree of interest corresponding to the calculation criterion, for example, as 10 steps based on the calculation criterion. Subsequently, the degree-of-interest calculation unit 28 weights the calculated degree of interest corresponding to the calculation criterion with the weight of the calculation criterion to calculate the weighted degree of interest based on the calculation criterion.

Further, when the degree-of-interest calculation unit 28 calculates the weighted degree of interest in combination of two or more calculation criteria, the degree-of-interest calculation unit 28 similarly calculates the degree of interest corresponding to each of the two or more calculation criteria, for example, as 10 steps based on each of the two or more calculation criteria. Subsequently, the degree-of-interest calculation unit 28 weights the calculated degree of interest corresponding to each of the two or more calculation criteria with the corresponding weight of the calculation criterion, and sums all weighted degrees of interest corresponding to the two or more calculation criteria to calculate the weighted degree of interest in combination of the two or more calculation criteria.

Further, when the degree-of-interest calculation unit 28 calculates the degree of interest in combination of two or more calculation criteria, the degree-of-interest calculation unit 28 may select two or more calculation criteria of which the weight is equal to or greater than a fifteenth threshold value set in advance from among the two or more calculation criteria, and calculate a weighted degree of interest in a combination of the two or more selected calculation criteria. Accordingly, even when there are a number of calculation criteria, it is possible to shorten the calculation time of the degree of interest.

Further, while calculation criteria 1 to 23 are classified into five groups in the above example, classifying into groups is not essential, and a different weight may be set for each calculation criterion.

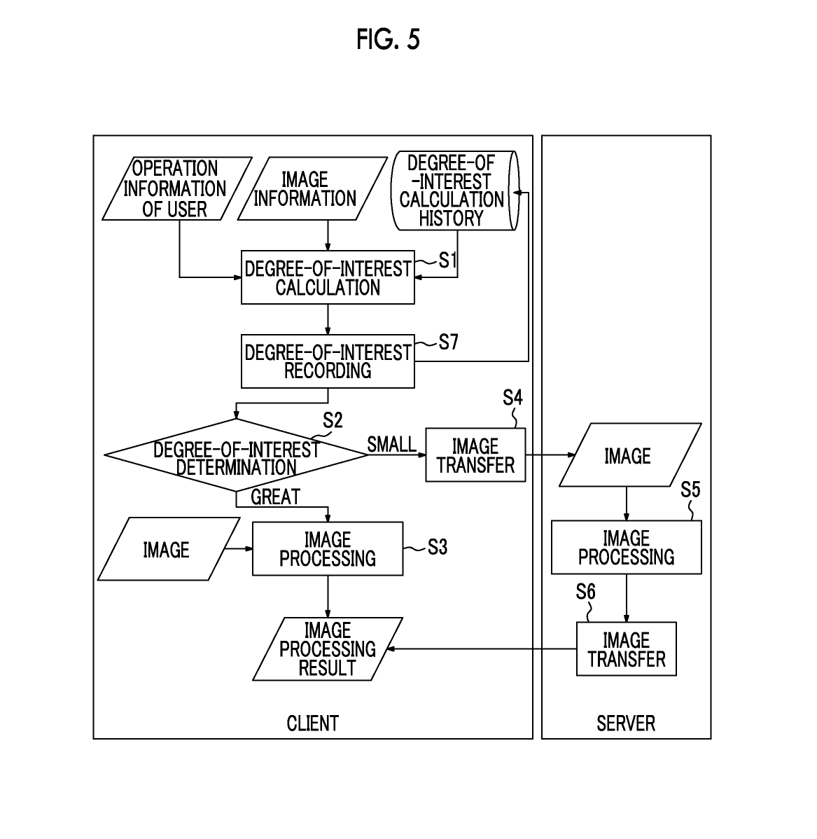

Further, a degree-of-interest recording unit is provided in the client 16, and, as shown in the flowchart of FIG. 5, each time the degree-of-interest calculation unit 28 calculates the degree of interest (Step S1), degree-of-interest calculation criteria and a calculation result history (degree-of-interest calculation history) are recorded by the degree-of-interest recording unit (step S7), and the degree-of-interest calculation history recorded in the degree-of-interest recording unit may be used for subsequent calculation of the degree of interest in the degree-of-interest calculation unit 28.

In this case, the degree-of-interest calculation unit 28 calculates the degree of interest based on the degree-of-interest calculation history in addition to the operation information of the user and the image information. Accordingly, the calculation criteria and the result of calculation of the degree of interest can be optimized according to individual users.

Further, in FIG. 5, steps other than steps S1 and S7 are the same as those in FIG. 4.

As described in the calculation criteria 23, an image satisfying a frequent photography condition of the user can be considered as having a high degree of interest of the user. For example, in the case of a user usually having a number of images captured in the evening, images of which the photographing date and time is 17 o'clock can be determined to have a high degree of interest of the user. Conversely, an image satisfying a usually infrequent photography condition of the user can also be considered as having a high degree of interest of the user. For example, in the case of a user usually having a number of images captured with a wide angle, an image captured at a telephoto can be determined to have a high degree of interest of the user.

Further, a result of calculation of the degree of interest corresponding to the operation information of the user and the image information from among the degree-of-interest calculation history by the degree-of-interest calculation unit 28 may be used as the calculated degree of interest. Accordingly, it is possible to shorten a calculation time of the degree-of-interest.

For example, when the calculation criterion is the number of pixels in the image, a result of calculation of the degree of interest corresponding to the calculation criteria for the number of pixels in the image from among the degree-of-interest calculation history is used as the calculated degree of interest. The same applies to the other calculation criteria.

Further, a technology for applying, as a sensitivity tag, a sensitivity term indicating sensitivity of the image such as cute, fun, cool, or chic to the image is known. This sensitivity tag may be used as information regarding the image for calculation and determination of the degree of interest of the user in the image.

In this case, the degree-of-interest calculation unit 28 calculates, as the degree of interest, an occupancy rate of each sensitivity tag in the image owned by the user based on the information regarding the sensitivity tag assigned to each image owned by the user.

Also, the degree-of-interest determination unit 30 determines that, for example, the image with the sensitivity tag of which the rate is greater (or smaller) than a threshold value set in advance has a high degree of interest.

Alternatively, the degree-of-interest calculation unit 28 calculates, as the degree of interest, the number of images with respective sensitivity tags among images that are current image processing targets based on the information regarding the sensitivity tags assigned to the respective images that are the current image processing targets.

Also, the degree-of-interest determination unit 30 determines that, for example, the image with relatively most (or least) sensitivity tags has a high degree of interest.

For example, the sensitivity tag having a great rate (for example, the sensitivity tag “cute” occupies 50%) matches the preference of the user, and the degree of interest can be determined to be high.

Conversely, since the sensitivity tag having a small rate (for example, the sensitivity tag “cool” occupies 1%) is likely to be special for the user, the degree of interest can be determined to be high.

While the above example is a case in which only images that are current image processing targets are used for determination of the degrees of interest, the information regarding images that are past image processing targets and their sensitivity tags may be recorded and the degree of interest may be calculated and determined based on statistical information thereof.

For example, when there are statistically images with specific sensitivity tags (the number of images is greater than a threshold value that is set in advance) among the images that are past processing targets, images with the same sensitivity tag can be determined to have a high degree of interest of the user.

Conversely, an image with a sensitivity tag that hardly statistically appears (the number of images is smaller than a threshold value) attracts interest of the user and can be determined to have a high degree of interest.

Further, the user operation information may be reflected in the statistical information.

For example, when the user performs action determined to have a high degree of interest, for example, the user operates an image with a sensitivity tag, performs an order, or shares an image with another person, a weight for the sensitivity tag increases. That is, the degree of interest calculated based on the statistical information is weighted according to the operation information of the user.

For example, in the case of an example shown in Table 1, since a rate of the sensitivity tag “chic” is as small as 10%, and thus, a weight by rate is as small as 1 in five steps from low 1 to high 5. However, the user performs an important action of ordering an image with the sensitivity tag “chic”. Therefore, since the image with the sensitivity tag “chic” can be determined to have a high degree of interest of the user, a weight by action is as great as 10 in 10 steps from low 1 to high 10. As a result, the degree of interest of the image with the sensitivity tag “chic” is set to 11, in addition to the weight by rate of 1 and the weight by action of 10.

TABLE 1

| Sensi- | | Weight by | | Weight by | |
|---|---|---|---|---|---|
| tivity | | rate (low 1 | | action (low 1 | Degree of |
| tag | Rate | to high 5) | Action of user | to high 10) | interest |
| Cute | 70% | 4 | Image is viewed | 2 | 6 |
| Cool | 20% | 2 | Image is edited | 5 | 7 |
| Chic | 10% | 1 | Image is ordered | 10 | 11 |

Further, when the image processing has been performed in the server 12, it is not necessary to immediately transfer the image on which the image processing has been performed to the client 16. The image subjected to image processing in the server 12 is an image in which the degree of interest of the user is low, and the image on which the image processing has been performed is considered to be less immediately required by the client 16. Therefore, after the image processing has been performed in the server 12, the server 12 holds the image on which the image processing has been performed until the client 16 requires the image on which the image processing has been performed. When the client 16 requires the image on which the image processing has been performed, the control unit 36 may perform control so that the image on which the image processing has been performed may be transferred from the server 12 to the client 16.

Further, when the size (capacity) of the image that is an image processing target is large, time of communication to the server 12 may increase and a processing time may be much consumed. Conversely, when the size of the image is small, the communication time may be neglected. Therefore, the size of the image may be added to the calculation criteria.

For example, when the size of the image is equal to or greater than a sixteenth threshold value set in advance, the communication time is long, and thus, it is preferable for the control unit 36 to perform client processing regardless of the degree of interest of the user.

On the other hand, when the size of the image is smaller than the sixteenth threshold value and smaller than a seventeenth threshold value set in advance, the communication time can be neglected, and thus, it is preferable to perform the server processing regardless of the degree of interest of the user.

Further, when the size of the image is equal to or greater than the seventeenth threshold value and less than the sixteenth threshold value, client processing is performed if the degree of interest of the user is equal to or greater than the first threshold value, and server processing is performed if the degree of interest of the user is smaller than the first threshold value.

A target of interest of the user is not always constant. Therefore, even when an image is an image in which the degree of interest has already been calculated, when image processing is performed in the client 16 or the image in which the degree of interest has already been calculated is operated by the user before the image is transferred to the server 12, it is preferable for the degree-of-interest calculation unit 28 to re-calculate the degree of interest in the image in which the degree of interest of the user has been calculated, based on the operation information of the user (a current operation situation of the user) for the image in which the degree of interest has been calculated, which has been operated by a user.

For example, the image in which the degree of interest of the user has increased as a result of the degree of degree-of-interest calculation unit 28 re-calculating the degree of interest even when the image has been determined to be a server processing target is controlled by the control unit 36 for changing from server processing to client processing.

On the other hand, the image in which the degree of interest of the user has decreased as a result of the degree of degree-of-interest calculation unit 28 re-calculating the degree of interest even when the image has been determined to be a client processing target is controlled by the control unit 36 for changing from client processing to server processing.

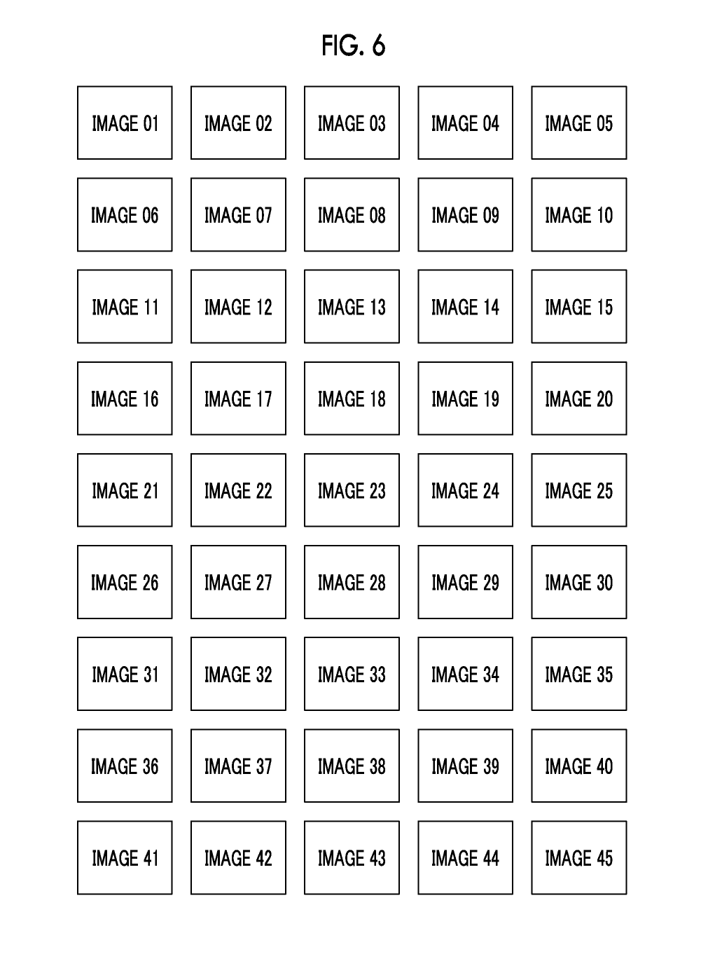

FIG. 6 is a conceptual diagram of an example illustrating images owned by the user. FIG. 6 shows the images owned by the user, which are a total of 45 images (image 01 to image 45) of nine rows×five columns stored in the client 16.

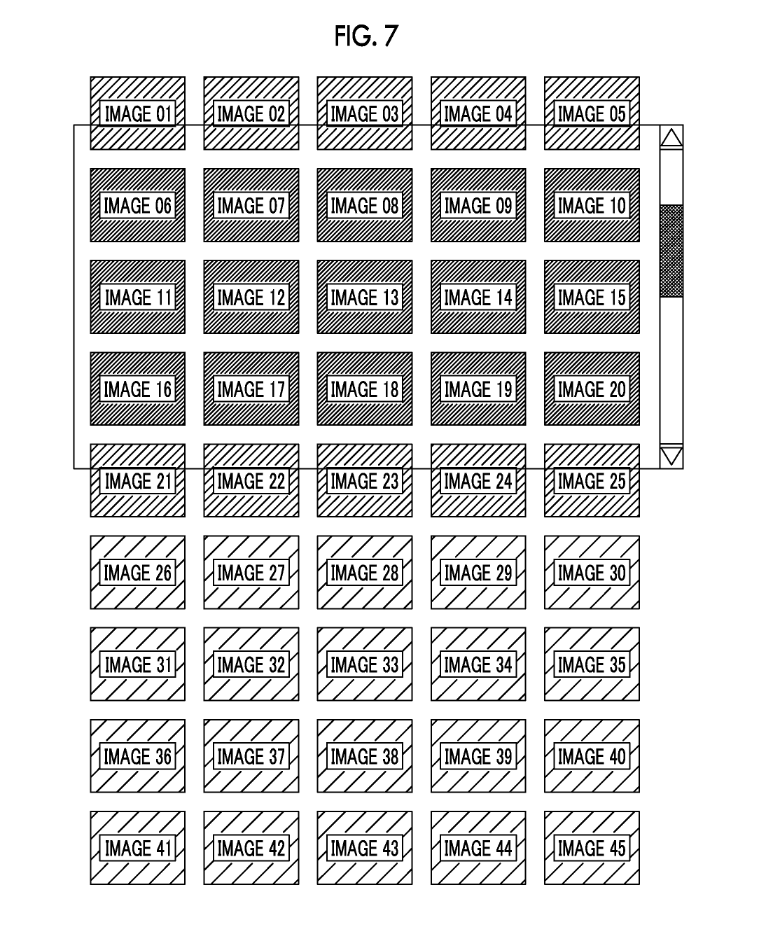

Then, FIG. 7 is a conceptual diagram of an example illustrating some images displayed on the display unit among the images illustrated in FIG. 6. FIG. 7 shows 15 images (image 06 to image 20) in the second to fourth rows, enclosed by a frame line, which are displayed on the display unit 38 among the 45 images illustrated in FIG. 6.

In this case, the degree-of-interest calculation unit 28 determines that the degree of interest of the user for 15 images in second to fourth rows displayed on the display unit 38 is high, the degree of interest of the user for 10 images in the first and fifth rows partially displayed on the display unit 38 over and under the images in the second to fourth rows is intermediate, and the degree of interest of the user for 20 images in the sixth to ninth rows not displayed on the display unit 38 is low. Therefore, the control unit 36 performs control so that client processing is performed on the 15 images in the second to fourth rows and server processing is performed on the 20 images in the sixth to ninth rows.

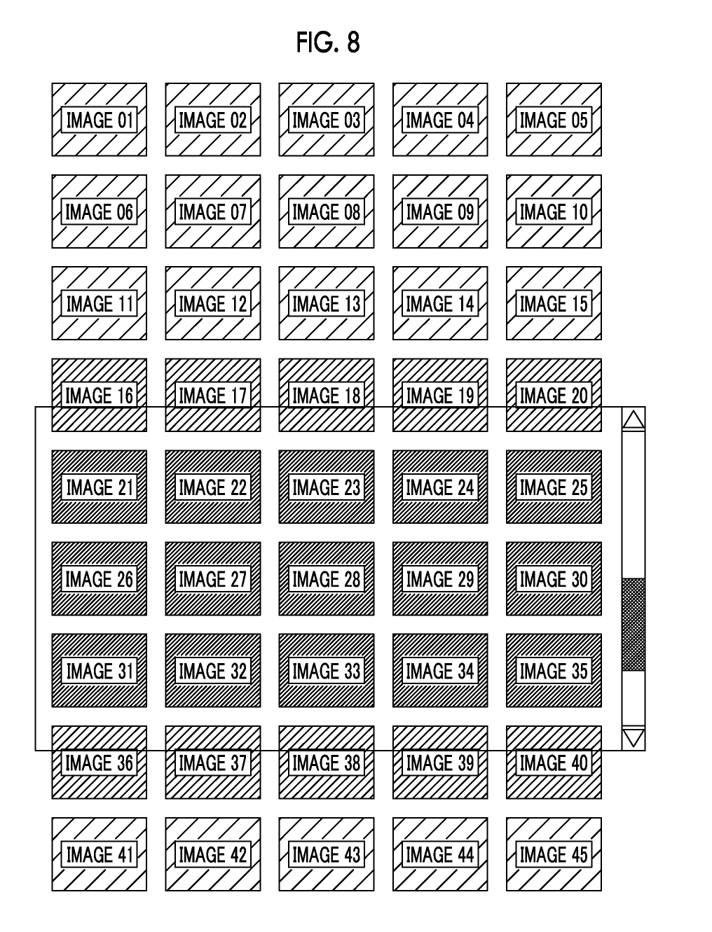

Then, FIG. 8 is a conceptual diagram of an example illustrating images in another portion displayed on the display unit among the images illustrated in FIG. 6. FIG. 8 corresponds to a case in which the images displayed on the display unit 38 are scrolled from a state illustrated in FIG. 7 by the user and the images in the other portion among the 45 images illustrated in FIG. 6 are displayed, and shows 15 images (image 21 to image 35) in the fifth to seventh rows, enclosed by a frame line, which are displayed on the display unit 38 in this case.

When the images displayed on the display unit 38 have changed, the degree-of-interest calculation unit 28 re-calculates the degree of interest. As a result, in the example illustrated in FIG. 8, the degree-of-interest calculation unit 28 determines that the degree of interest of the user for 15 images in the fifth to seventh rows displayed on the display unit 38 is high, the degree of interest of the user for 10 images in the fourth and eighth rows partially displayed on the display unit 38 over and under the images in the fifth to seventh rows is intermediate, and the degree of interest of the user for 20 images in the first to third and ninth rows not displayed on the display unit 38 is low. Therefore, the control unit 36 performs control so that client processing is performed on the 15 images in the fifth to seventh rows and server processing is performed on the 20 images in the first to third and ninth rows.

Thus, by re-calculating the degree of interest from time to time according to the user operation information (a current operation situation of the user), it is possible to always calculate the degree of interest according to a recent situation and determine whether to perform client processing or server processing.

Further, in another example of the case in which the degree of interest is re-calculated, when the number of operations of the user for an image exceeds a twentieth threshold value set in advance, it can be determined that the degree of interest of the user in the image of which the number of operations exceeds the twentieth threshold value has increased. Further, when the user uploads the image to the SNS, it can be determined that the degree of interest of the user in the uploaded image has increased. Further, the same determination can be made according to operation information other than the current user operation information illustrated here.

Further, the degree-of-interest calculation unit 28 can sequentially perform calculations of the degrees of interest of the user in all the images, the degree-of-interest determination unit 30 can sequentially determine whether the degree of interest is equal to or greater than the first threshold value for all the images, and then, the control unit 36 can perform control to sequentially determine whether to perform client processing or server processing for all the images based on the determination result of the degree of interest.

Meanwhile, the degree-of-interest determination unit 30 performing the determination as to whether the degree of interest is equal to or greater than the first threshold value, and the control unit 36 performing control to determine whether the image in which the degree of interest has been calculated is set to the client processing target or the server processing target based on a determination result of the degree of interest each time the degree-of-interest calculation unit 28 calculates the degree of interest of the user in one image can be sequentially performed for all the images.

Therefore, there also are a case in which the degree of interest is calculated according to the operation of the user by the degree-of-interest calculation unit 28, a case in which an image is an image in which the degree of interest has already been calculated or a case in which an image is an image in which the degree of interest has not been yet calculated, and a case in which both are mixed. That is, the degree-of-interest calculation unit 28 re-calculates the degree of interest according to the user operation in the case of the image in which the degree of interest has already been calculated, and calculates the degree of interest according to the user operation in the case of the image in which the degree of interest has not been yet calculated.

Further, when the degree of interest is re-calculated from time to time according to the user operation, the degree of interest is considered to be frequently changed. Therefore, it is preferable that, for example, when the image in which the degree of interest has been calculated is operated by the user, the degree-of-interest calculation unit 28 stores the user operation information (user operation history) for the image in which the degree of interest has been calculated for a certain time set in advance, and re-calculates the degree of interest of the user in the image in which the degree of interest has been calculated based on the user operation information for the image in which the degree of interest has been calculated, which has been stored for the certain time.

Further, when the degree of interest is calculated based on the number of times the user operated the image in the past or a time for which the user operated the image in the past as in calculation criteria 4 and 5 described above, it is preferable that it is determined whether the operation of the user is intended or not intended, and then the number of operations or the operation time is counted.

That is, if a re-operation has been performed after an operation of the image has been performed by the user, the number of the re-operations or the re-operation time is assumed not to be counted in the number of times the user operated the image in the past or the time for which the user operated the image in the past. When the operation and the re-operation for the image are performed the number of times smaller than an eighteenth threshold value set in advance, such as only once, the operation can be regarded as having been canceled.

However, even when re-operation is performed by the user, if the operation and the re-operation are performed on the same image several times, the user is likely to repeat trial and error on the image, and thus, the number of operations or the operation time may be counted in the number of times the user operated the image in the past or the time for which the user operated the image in the past. When the operation and the re-operation for the same image are performed the number of times equal to or greater than an eighteenth threshold value, such as three times or more, by the user, the operation may be regarded as the user suffering from trial and error for the image.

Further, when the image is not operated for a certain time by the user, the user is likely to leave from a seat or perform another work, and thus, the certain time for which the image is not operated by the user is not counted in time for which the image was operated by the user in the past.

Further, the image having a high degree of interest unconditionally is not the client processing target, but the following internal states, external environments, or the like of the mobile terminal (client 16) as shown in (1) to (8) may be added to the calculation criteria. In this case, a process of measuring, for example, performance or a communication speed of the mobile terminal is performed so as to perform the calculation of the degree of interest using the following calculation criteria (1) to (8). The measurement process is performed once, for example, at the time of starting up an application of the mobile terminal that implements the present invention, and then, performed at regular intervals.

(1) Performance (Speed of CPU (Central Processing Unit), Memory Capacity, and the Like) of the Mobile Terminal

As the performance of the mobile terminal is higher, the number of images simultaneously subjected to client processing increases.

For example, when the number of cores of a CPU of the mobile terminal is 4 or more and a clock frequency is 1.5 GHz or more, client processing of a maximum of four images is simultaneously performed. When the number of images to be simultaneously processed exceeds 4, the images are processed in the server 12.

(2) Load Situation of the Mobile Terminal

As a load of the mobile terminal (CPU use rate, an amount of memory use, or the like) increases due to, for example, an operation of another application or the like on the mobile terminal, the number of images that are client processing targets decreases so that operability of the user is not impaired.

For example, client processing is performed as long as a condition that the CPU use rate is equal to or less than 50% and the amount of memory use is equal to or less than 100 MB is satisfied.

(3) Operation Situation of the Server

When the server processing cannot be performed according to the operation situation of the server 12 such as a large load of the server 12 or trouble occurrence in the server 12, the client processing is performed.

For example, when time required for the server processing exceeds 30 seconds per image or an error is returned from the server 12, the client processing is performed.

(4) Communication Speed Between the Mobile Terminal and the Server

When a high-speed communication environment such as a Wi-Fi (Wireless Fidelity) connection or an LTE (Long Term Evolution) connection is available and communication speed between both parties is higher than a nineteenth threshold value set in advance, a problem with a communication time that is a disadvantage of the server processing is negligible, and thus, the number of images that is a server processing target increases. For example, when a response time of the server 12 is less than 100 [ms], the client processing is not performed, and all images become server processing targets.

(5) Type of Communication Line

When a communication line using a use-based billing scheme is used between the mobile terminal and the server 12, the number of images that are server processing targets decreases so that a burden of a cost on the user is not caused.

For example, when communication with the server 12 is via a mobile carrier and there is a contractual limitation on a data communication capacity, server processing is not performed and all images are client processing targets.

(6) A Plurality of Servers

When there are a plurality of servers 12, image processing is performed on an image having a relatively higher degree of interest in the server in which time required for image processing is shorter, such as a server closer in the network, or a higher performance server.

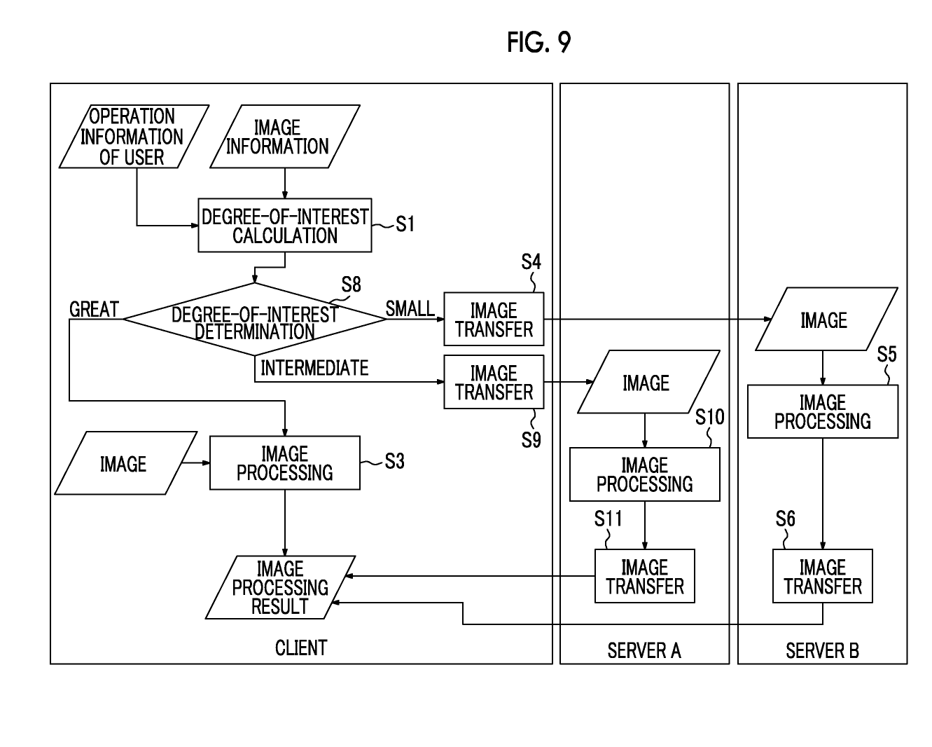

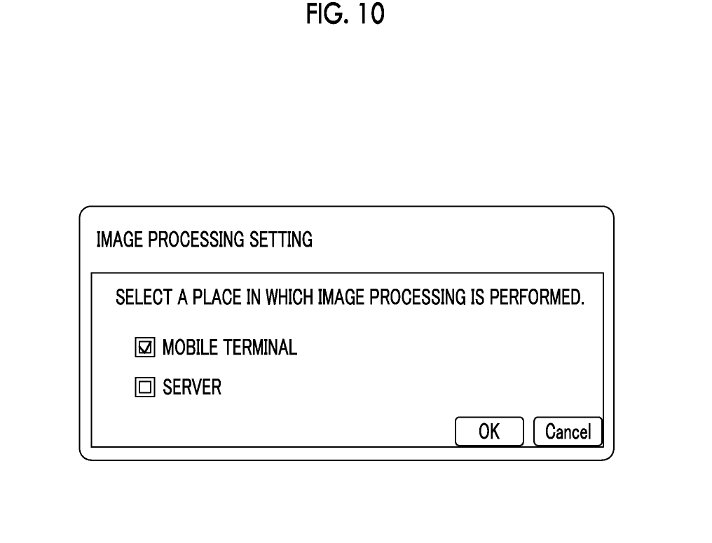

In this case, as shown in a flowchart of FIG. 9, it is determined whether the degree of interest is high, intermediate, or low (step S8).

Here, an image in which the degree of interest of the user is determined to be high (“great” in step S8) is subjected to image processing in the client 16.

When processing time of the server A (+transfer time)<processing time of the server B (+transfer time), an image in which the degree of interest is determined to be intermediate (“intermediate” in step S8) is subjected to image processing in the server A (steps S9 to S11), and an image in which the degree of interest is determined to be low (“small” in step S8) is subjected to image processing in the server B (steps S4 to S6).

Further, even when there are a plurality of servers, not all the servers 12 provide the same image processing function. The server 12 to perform image processing is determined according to the image processing functions provided by the respective servers 12 so that desired image processing is performed in the server 12 that provides a function of performing the desired image processing.

For example, when a face detection function is provided as the image processing function in the server A and an image correction function is provided as the image processing function in the server B, the face detection process is shared between the client 16 and the server A.

(7) A Plurality of Clients

When there are a plurality of clients 16 such as a mobile terminal, a tablet terminal, and a PC on a network used by the user, these are added to process sharing targets.

For example, an image having a high degree of interest is processed in the mobile terminal that the user is currently operating, an image having an intermediate degree of interest is processed in a tablet terminal or a PC that the user is not currently using, and an image having a low degree of interest is processed in the server 12.

(8) Selection of an Image Processing Place

Since there also is a user with a desire to limit a place in which the image processing is performed, the user is allowed to set whether the image processing is performed in either the client 16 or the server 12.

For example, there are desires to process the image always in the client 16 due to the user hating to upload personal information to the server 12, to process the image always in the client 16 due to restrictions on an amount of network transfer, and to process the image always in the server 12 due to a low specification of the client 16.

In this case, the client 16 further includes an image processing place designation unit to determine whether the image processing is performed in the server 12 or in the client 16 according to the image processing place designated by the image processing place designation unit. That is, the image processing is performed in the server 12 when the server 12 is designated by the image processing place designation unit, and in the client 16 when the client 16 is designated.

As illustrated in FIG. 10, it is preferable for the image processing place designation unit to display a GUI (Graphical User Interface) screen for enabling the user to designate a place at which image processing is performed on the display unit 38 of the client 16 currently operated by the user. Accordingly, the user can designate a desired image processing place through the GUI displayed on the display unit 38 of the client 16 that is being operated.

Further, for the respective images, all processes of the image processing for one image may not be performed in any one of the client 16 and the server 12, but it may be determined whether the remaining processes (post-processing) of the image processing continue to be performed in the client 16 or are performed in the server 12 based on the degree of interest after only some (pre-processing) of the processes of the image processing are performed in the client 16.

Examples of the image processing performed in the client 16 may include face detection, face recognition, and scene discrimination.

For example, since an image in which a face is photographed as a result of performing the face detection in the client 16, an image in which a specific person is photographed as a result of performing the face recognition in the client 16, and an image in which a specific scene is photographed as a result of performing the scene discrimination in the client 16 are considered as having a high degree of interest of the user, the remainder of the image processing continues to be performed in the client 16. On the other hand, since other images are considered as having a low degree of interest of the user, the remainder of the image processing is performed in the server 12.

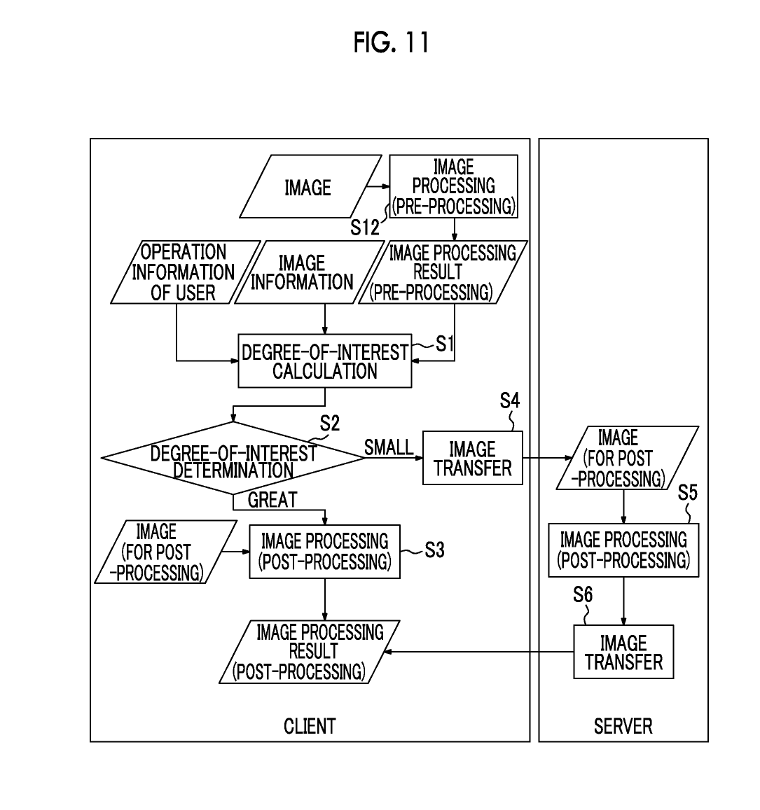

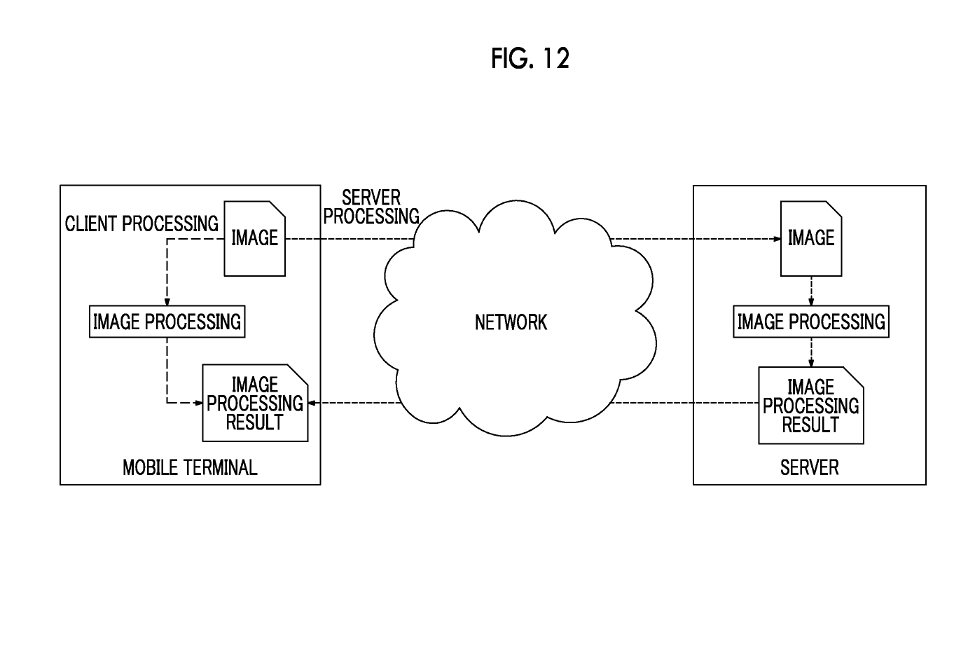

In this case, as illustrated in the flowchart of FIG. 11, pre-processing is performed on the image in the client 16, and an image on which the pre-processing has been performed is stored as an image processing result (step S12).

Subsequently, the degree of interest of the user in the image is calculated based on the operation information of the user and the information regarding the image (step S1), and it is determined whether the degree of interest is equal to or greater than the first threshold value (greater or smaller than the first threshold value) (step S2).

Here, image processing is performed on the image determined to have a high degree of interest (“great” in step S2) in the client 16 (step S3), and an image on which post-processing has been performed by the client is stored as an image processing result.

On the other hand, image processing is performed on the image determined to have a low degree of interest (“small” in step S2) in the server 12 (steps S4 to S6), and an image on which post-processing has been performed by the server is stored as an image processing result.

Since only the remaining processes of the image processing are performed in the server 12, it is not necessary to transfer all pieces of data regarding the image processing to the server 12, and only data necessary for the remaining processes of the image processing may be transferred. Thus, it is possible to reduce an amount of data transfer.

Further, there are a variety of types of image processing, and their effects given to the user are different. Therefore, image processing of which the effect given to the user is great may preferentially be client processing, and image processing of which the effect given to the user is small may be server processing.

For example, since a result of performing image correction or face detection can be visually confirmed by the user, the effect given to the user is great, and thus, the processing is performed in the client 16.

On the other hand, since a result of performing a blur determination of the image is not visible to the user, the effect given to the user is small, and thus, the processing is performed in the server 12.

Further, the degree of interest can be not only used for sharing of image processing between the client 16 and the server 12, but also used for other uses.

For example, an image having a high degree of interest can be automatically uploaded to the server 12 or backed up, a sample of a photo merchandise (content) such as a photo book is created using the image having a high degree of interest and displayed on the display unit 38 of the client 16 to be suggested to the user, or the degree of interest can be used for various other uses.

In the apparatus of the present invention, each component included in the apparatus may be configured of dedicated hardware or may be configured of a programmed computer.

The method of the present invention, for example, can be implemented by a program for causing a computer to execute the respective steps of the method. Further, it is also possible to provide a computer-readable recording medium having the program recorded thereon.

The present invention is basically as described above.

While the present invention has been described above in detail, the present invention is not limited to the above embodiments, and it is understood that various improvements and modifications may be made without departing from the scope and spirit of the present invention.

What is claimed is:

1. An image processing system which shares image processing on a plurality of images between a server and a client connected to the server over a network,
wherein the server includes a first image processing unit configured to perform image processing on an image received from the client, and
wherein the client includes:
a degree-of-interest calculation unit configured to calculate a degree of interest of the user in the image based on operation information, which is indicative of information regarding an operation performed by a user, and information regarding the image;
a degree-of-interest determination unit configured to determine whether the degree of interest is equal to or greater than a first threshold value;
a second image processing unit configured to perform image processing on the image; and
a control unit configured to control the second image processing unit to perform the image processing of the image for which the degree of interest is determined to be equal to or greater than the first threshold value in a case where the degree-of-interest determination unit determines that the degree of interest is equal to or greater than the first threshold value, and to control the first image processing unit to perform the image processing on the image for which the degree of interest is determined to be smaller than the first threshold value in a case where the degree-of-interest determination unit determines that the degree of interest is smaller than the first threshold value.

2. The image processing system according to claim 1,
wherein the server further includes a first transfer unit configured to transfer data regarding the image processing between the server and the client,
wherein the client further includes a second transfer unit configured to transfer the data between the client and the server, and
wherein, in the case where the image processing is performed by the first image processing unit, the control unit controls:
the second transfer unit to transmit data regarding image processing of the image for which the degree of interest is determined to be smaller than the first threshold value from the client to the server;
the first transfer unit to receive the data regarding image processing of the image for which the degree of interest is determined to be smaller than the first threshold value from the client to the server;
the first image processing unit to perform image processing on the image in which the degree of interest is determined to be smaller than the first threshold value based on the data regarding image processing of the image in which the degree of interest is determined to be smaller than the first threshold value;
the first transfer unit to transmit the image on which the image processing has been performed from the server to the client; and
the second transfer unit to receive the image on which the image processing has been performed from the server to the client.

3. The image processing system according to claim 1,
wherein the operation information of the user includes at least one information type selected from a group of types consisted of image viewing, image editing, image ordering, and image sharing.

4. The image processing system according to claim 1,
wherein the information regarding the image include at least one information type selected from a group of types consisted of an owner of the image, a subject of the image, a photographing date and time of the image, a size of the image, and meta information of the image.

5. The image processing system according to claim 1,
wherein the degree-of-interest calculation unit calculates the degree of interest based on one of the following calculation criteria or a combination of two or more of the following calculation criteria:
(1) whether the image that is an image processing target is an image currently operated by the user;
(2) whether a photographing date of the image that is an image processing target is the same as a photographing date of an image currently operated by the user;
(3) whether the user operated the image that is an image processing target in the past;
(4) whether the number of times the user operated the image that is an image processing target in the past is greater than a second threshold value;
(5) whether a period of time for which the user operated the image that is an image processing target in the past is longer than a third threshold value;
(6) whether the image that is an image processing target is an image that the user has uploaded to an SNS;
(7) whether the image that is an image processing target is an image that the user has transmitted to another user;
(8) whether the image that is an image processing target is an image for which the user has performed a print order in the past;
(9) whether the image that is an image processing target is an image of which an original owner is the user or a user's family;
(10) whether a subject included in the image that is an image processing target is the user or a user's family, or a subject matching user's preference;
(11) whether a face of a subject included in the image that is an image processing target is larger than a fourth threshold value;
(12) whether the number of subjects included in the image that is an image processing target is greater than a fifth threshold value;
(13) whether a photographing date and time of the image that is an image processing target is an anniversary of the user or a user's family;
(14) whether a photographing date and time of the image that is an image processing target is more recent than a sixth threshold value;
(15) whether the number of pixels of the image that is an image processing target is greater than a seventh threshold value;
(16) whether an aspect ratio of the image that is an image processing target is different from an aspect ratio of another image;
(17) whether the image that is an image processing target is an image captured in a different photographing method from another image;
(18) whether the image that is an image processing target is an image captured the number of times equal to or greater than a ninth threshold value in a period of time shorter than an eighth threshold value;
(19) whether a photographing interval between the image that is an image processing target and an image captured before the image that is an image processing target is greater than a tenth threshold value;
(20) whether a photographing place of the image that is an image processing target is farther than an eleventh threshold value from within a living area of the user;
(21) whether the image that is an image processing target is a moving image, and a photographing time period of the image is greater than a twelfth threshold value;
(22) whether the image that is an image processing target is an image which has been processed by the user or an image which has been subjected to a plurality of types of processing; and
(23) whether the image that is an image processing target is an image of which a photographing frequency is statistically higher than a thirteenth threshold value, or an image of which the photographing frequency is statistically lower than a fourteenth threshold value.

6. The image processing system according to claim 5,
wherein the degree-of-interest calculation unit performs weighting on the calculated degree of interest based on each of the calculation criteria according to a degree of importance of each calculation criterion.

7. The image processing system according to claim 6,
wherein in a case where the degree-of-interest calculation unit calculates the degree of interest in the combination of two or more of the calculation criteria, the degree-of-interest calculation unit selects two or more calculation criteria of which the weight is equal to or greater than a fifteenth threshold value from among the calculation criteria, and calculates the degree of interest on which the weighting has been performed in combination of the two or more selected calculation criteria.

8. The image processing system according to claim 1,
wherein the client further includes a degree-of-interest recording unit configured to store a history of the calculation criteria for the degree of interest and a calculation result each time the degree-of-interest calculation unit calculates the degree of interest, and
the degree-of-interest calculation unit calculates the degree of interest based on the history of the calculation criteria for the degree of interest and the calculation result, in addition to the operation information of the user and the information regarding the image.

9. The image processing system according to claim 8,
wherein the degree-of-interest calculation unit uses a result of calculation of the degree of interest corresponding to the operation information of the user and the information regarding the image from the history of the result of calculation of the degree of interest, as the calculated degree of interest.

10. The image processing system according to claim 1,
wherein the degree-of-interest calculation unit calculates the degree of interest based on a sensitivity tag indicative of sensitivity of the image, which tag is given to the image as the information regarding the image.

11. The image processing system according to claim 10,
wherein the degree-of-interest calculation unit calculates an occupancy rate of each sensitivity tag in an image that is a current image processing target based on the information regarding the sensitivity tag given to each image that is the current image processing target as the degree of interest.

12. The image processing system according to claim 10,
wherein the degree-of-interest calculation unit calculates the number of images to which respective sensitivity tags have been given among images that are current image processing targets based on information regarding the sensitivity tags given to the respective images that are the current image processing targets as the degree of interest.

13. The image processing system according to claim 10,
wherein the degree-of-interest calculation unit calculates the degree of interest based on statistical information of images that are past image processing targets and the sensitivity tags of the images that are past image processing targets.

14. The image processing system according to claim 13,
wherein the degree-of-interest calculation unit performs weighting on the degree of interest calculated based on the statistical information according to the operation information of the user.

15. The image processing system according to claim 1,
wherein the control unit controls the server to holds, after the image processing is performed by the first image processing unit, the image on which the image processing has been performed until the client requires the image on which the image processing has been performed, and controls the client to receives the image on which the image processing has been performed from the server when the client requires the image on which the image processing has been performed.

16. The image processing system according to claim 1,
wherein the control unit controls the second image processing unit to perform image processing on the image of which the size is equal to or greater than a sixteenth threshold value regardless of the degree of interest in a case where the size of the image is equal to or greater than the sixteenth threshold value, and controls the first image processing unit to perform the image processing on the image of which the size is less than a seventeenth threshold value regardless of the degree of interest in a case where the size of the image is less than the seventeenth threshold value, which is smaller than the sixteenth threshold value.

17. The image processing system according to claim 1,
wherein, in a case where the image in which the degree of interest has been calculated is subjected to the image processing by the second image processing unit or the image in which the degree of interest has been calculated is operated by the user before the image is transmitted to the server, the degree-of-interest calculation unit re-calculates the degree of interest of the user in the image in which the degree of interest has been calculated, based on the operation information of the user for the image in which the degree of interest has been calculated, which has been operated by the user.

18. The image processing system according to claim 17,
wherein in a case where an image in which the degree of interest has been calculated is operated by the user, the degree-of-interest calculation unit stores operation information of the user for the image in which the degree of interest has been calculated for a certain period of time, and re-calculates the degree of interest of the user in the image in which the degree of interest has been calculated, based on the operation information of the user for the image in which the degree of interest has been calculated, which is stored for the certain time.

19. The image processing system according to claim 1,
wherein in a case where the degree-of-interest calculation unit calculates the degree of interest based on the number of times or a period of time for which the user operated the image in the past, the degree-of-interest calculation unit does not count the number of re-operations or a re-operation period of time in the number of times or the period of time for which the user operated the image in the past if the operation and the re-operation are performed the number of times less than an eighteenth threshold value by the user.

20. The image processing system according to claim 19,
wherein in a case where the operation and the re-operation are performed the number of times equal to or greater than the eighteenth threshold value by the user, the degree-of-interest calculation unit counts the number or the time of re-operations in the number of times or time for which the user operated the image in the past.

21. The image processing system according to claim 1,
wherein in a case where the degree-of-interest calculation unit calculates the degree of interest based on a period of time for which the user operated an image in the past, if the image has not been operated for a certain period of time by the user, the certain period of time for which the image has not been operated by the user is not counted in the period of time time for which the user operated the image in the past.

22. The image processing system according to claim 1,
wherein in a case where the image processing is performed by the second image processing unit, the control unit controls the second image processing unit to increase the number of images simultaneously subjected to the image processing in accordance with increase of performance of the client.

23. The image processing system according to claim 1,
wherein in a case where the image processing is performed by the second image processing unit, the control unit controls the second image processing unit to decrease the number of images subjected to the image processing in accordance with increase of a load of the client.

24. The image processing system according to claim 1,
wherein in a case where the image processing is unable to be performed by the first image processing unit due to an operation situation of the server, the control unit controls the second image processing unit to perform the image processing.

25. The image processing system according to claim 1,
wherein in a case where a communication speed between the client and the server is equal to or greater than a nineteenth threshold value, the control unit controls the image processing unit to increase the number of images subjected to image processing.

26. The image processing system according to claim 1,
wherein in a case where a communication line of a use-based billing scheme is used between the client and the server, the control unit controls the first image processing unit to decrease the number of images subjected to image processing.

27. The image processing system according to claim 1,
wherein in a case where there are two or more servers, the control unit performs control in such a manner that the image processing is performed on an image in which the degree of interest is higher in a server in which time required for image processing is shorter.

28. The image processing system according to claim 1,
wherein in a case where there are two or more servers, the control unit performs control in such a manner that a desired image processing is performed in a server that provides a function of performing the desired image processing.

29. The image processing system according to claim 1,
wherein in a case where there are two or more clients, the control unit controls a client that is currently operated by the user to perform image processing on an image having a higher degree of interest than an image on which image processing is performed by a client that is not currently operated by the user.

30. The image processing system according to claim 1,
wherein the client further includes an image processing place designation unit configured to designate a place at which the image processing is performed, and
the control unit controls the first image processing unit or the second image processing unit to perform the image processing according to the place at which the image processing is performed, which is designated by the image processing place designation unit.

31. The image processing system according to claim 30,
wherein the image processing place designation unit displays a GUI screen for enabling the user to designate a place at which the image processing is performed on a display unit of a client currently operated by the user.

32. The image processing system according to claim 1,
wherein the control unit determines whether remaining processes of the image processing continue to be performed by the second image processing unit or are performed by the first image processing unit based on the degree of interest after only some of processes of the image processing are performed by the second image processing unit.

33. The image processing system according to claim 1,
wherein the control unit performs control in such a manner that the image processing is performed in the client in a case where the image processing is image processing in which the user is able to visually confirm a processing result, and the image processing is performed in the server when the image processing is image processing in which the user is unable to visually confirm a processing result.

34. A client used in an image processing system which shares image processing on a plurality of images between a server and a client connected to the server over a network, the client comprising:
a degree-of-interest calculation unit configured to calculate a degree of interest of the user in the image based on operation information, which is indicative of information regarding an operation performed by a user, and information regarding the image;
a degree-of-interest determination unit configured to determine whether the degree of interest is equal to or greater than a first threshold value;
a second image processing unit configured to perform image processing on the image; and
a control unit configured to control the second image processing unit to perform the image processing on the image in which the degree of interest is determined to be equal to or greater than the first threshold value in a case where the degree-of-interest determination unit determines that the degree of interest is equal to or greater than the first threshold value, and controls a first image processing unit included in the server to perform the image processing on the image in which the degree of interest is determined to be smaller than the first threshold value in a case where the degree-of-interest determination unit determines that the degree of interest is smaller than the first threshold value.

35. The client according to claim 34, further comprising:
a second transfer unit configured to transfer data regarding the image processing between the client and the server, and
wherein in the case where the image processing is performed by the first image processing unit, the control unit controls:
the second transfer unit to transmit data regarding image processing of the image in which the degree of interest is determined to be smaller than the first threshold value from the client to the server by the second transfer unit;
the first transfer unit included in the server to receive the data regarding image processing of the image in which the degree of interest is determined to be smaller than the first threshold value from the client to the server;
the first image processing unit to perform image processing on the image in which the degree of interest is determined to be smaller than the first threshold value based on the data regarding image processing of the image in which the degree of interest is determined to be smaller than the first threshold value;
the first transfer unit to transmit the image on which the image processing has been performed from the server to the client; and
the second transfer unit to receive the image on which the image processing has been performed from the server to the client.

36. An image processing method for performing image processing on a plurality of images through sharing between a server and a client connected to the server over a network, the method comprising:
causing a degree-of-interest calculation unit of the client to calculate a degree of interest of the user in the image based on operation information, which is indicative of information regarding an operation performed by a user, and information regarding the image;
causing a degree-of-interest determination unit of the client to determine whether the degree of interest is equal to or greater than a first threshold value; and
causing a control unit to control the second image processing unit of the client to perform image processing on the image in which the degree of interest is determined to be equal to or greater than the first threshold value in a case where the degree-of-interest determination unit determines that the degree of interest is equal to or greater than the first threshold value, and control the first image processing unit of the server to perform the image processing on the image in which the degree of interest is determined to be smaller than the first threshold value in a case where the degree-of-interest determination unit determines that the degree of interest is smaller than the first threshold value.

37. The image processing method according to claim 36, further comprising:
in a case where the image processing is performed by the first image processing unit,
causing a second transfer unit of the client to transmit data regarding image processing of the image in which the degree of interest is determined to be smaller than the first threshold value from the client to the server;
causing a first transfer unit of the server to receive the data regarding image processing of the image in which the degree of interest is determined to be smaller than the first threshold value from the client to the server;
causing the first image processing unit to perform image processing on the image in which the degree of interest is determined to be smaller than the first threshold value based on the data regarding image processing of the image in which the degree of interest is determined to be smaller than the first threshold value;
causing the first transfer unit to transmit an image on which the image processing has been performed from the server to the client; and
causing the second transfer unit to receive the image on which the image processing has been performed from the server to the client.

38. A non-transitory computer-readable recording medium having a program recorded thereon for causing a computer to execute each of the image processing methods according to claim 36.
